(19) United States
(12) Patent Application Publication
(10) Pub. No.: US 2012/0266171 A1
(43) Pub. Date: Oct. 18, 2012

(54) APPARATUS AND METHOD FOR CARRYING OUT A MIGRATION PROCESS OF A VIRTUAL MACHINE IN A DEVICE

(75) Inventors: Ji-Woong Byun, Seoul (KR); Jae-Wook Jeon, Suwon-si (KR); Seong-Jin Cho, Suwon-si (KR); Jong-Hyun Park, Suwon-si (KR); Sang-Chul Lee, Suwon-si (KR); Hae-Il Hyun, Suwon-si (KR)

(73) Assignees: SUNGKYUNKWAN UNIVERSITY, Suwon-si (KR); SAMSUNG ELECTRONICS CO., LTD., Suwon-si (KR)

(21) Appl. No.: 13/446,969

(22) Filed: Apr. 13, 2012

(30) Foreign Application Priority Data
Apr. 14, 2011 (KR) 10-2011-0034727

(51) Int. Cl. G06F 9/455

(52) U.S. Cl. 718/1

(57) ABSTRACT

A device carries out virtualization technology. An apparatus and a method in which an operating system or a program migrates a virtual machine during implementing in the device to a different type of device. The apparatus for migrating the virtual machine in the device may comprise an input unit for requesting the migration of the virtual machine, a display for displaying the migration process of the virtual machine, a virtualization processing unit for creating the virtual machine to run an application corresponding to a plural of operating system and for collecting the data related to the application run through the virtual machine and a controller for transmitting the data related to the application run through the virtual machine to a peripheral device using a different instruction set architecture.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Apr. 14, 2011, and assigned Serial No. 10-2011-0034727, the entire disclosure of which is hereby incorporated by reference.

The present application is also related to U.S. patent application Ser. No. ______, filed on Apr. 13, 2012, and entitled “APPARATUS AND METHOD FOR CONTROLLING A VIRTUAL MACHINE”. U.S. patent application Ser. No. ______ is assigned to the assignee of the present application and is hereby incorporated by reference into the present application as if fully set forth herein.

### TECHNICAL FIELD OF THE INVENTION

The present disclosure relates to a device to carry out virtualization technology, in particular an apparatus and a method in which an operating system or a program migrate a virtual machine carrying out during implementing in the device to a different type of device using a different architecture.

### BACKGROUND OF THE INVENTION

Recently, a portable terminal has been used by men and women of all ages as necessity for modern life, and a service provider and a terminal manufacturer have been developing competitively products (or service) for distinguishing his business from other business.

For example, the portable terminal has developed to a multimedia apparatus that can provide a phone book, a Short Message Service (SMS), an Electronic (E)-mail, a morning call, a Motion Picture Expert Group Audio Layer-3 (MP3), a schedule management function, a digital camera, a Multimedia Message Service (MMS) and a wireless internet service.

Recently, the function of the portable terminal has improved to support a plural of application software and has used multi-process structure for processing a great amount work.

For example, the portable terminal may use virtualization technology to utilize a plural of different types of processors.

The virtualization technology is technology to run a plural of operating systems in one terminal with virtualization layers (virtualization software) between operating system and application program of a mobile telecommunication terminal and, in recent, the virtualization migration technology with which the virtualization technology can be used in a peripheral terminal has been developed.

Using the virtualization immigration technology, a virtual machine operated in a mobile telecommunication terminal can be migrated to other terminal and the virtualization migration technology can be utilized between some terminals using instruction set architecture but cannot be utilized between other devices using different architecture.

That is, the migration technology can be utilized between some devices having identical architecture and, hence, an apparatus and a method for using the virtualization migration technology between some devices having different architectures may be required for resolving the above-mentioned problem.

### SUMMARY OF THE INVENTION

To address the above-discussed deficiencies of the prior art, it is an aspect of the present disclosure to provide an apparatus and method for virtual machine migration between different types of devices.

Another aspect of the present disclosure is to provide an apparatus and a method for processing an instruction word between devices using a dynamic binary converter in a device to which a virtualization machine is migrated from a different type of device.

In accordance with an aspect of the present disclosure, an apparatus to migrate a virtual machine in a device may comprise a input unit for requesting the migration of a virtual machine, a display for displaying the migration process of the virtual machine, a virtualization processing unit for creating and running an application corresponding to a plural of operating systems and collecting the data related to the application run through the virtual machine and a controller for controlling the transmission of the data related to the application run through the virtual machine to a peripheral device using a different instruction set architecture.

In accordance with another aspect of the present disclosure, the apparatus to which a virtual machine is migrated from a device may comprise a controller for receiving data related to an application run through the virtual machine from the device to request the migration of the virtual machine after transmitting a response to a request, if the request for migration of the virtual machine is received, a virtualization processing unit for running the virtual machine using the received data, wherein a dynamic binary converter included in virtualization layers converts instruction words suitable for the virtual machine and an operating system.

In accordance with another aspect of the present disclosure, a method for migrating a virtual machine from a device may comprise creating the virtual machine and running an application corresponding to a plural of operating systems, collecting data related to the application run through the virtual machine and providing a peripheral device using a different instruction set architecture with the collected data.

In accordance with another aspect of the present disclosure, a method for migrating a virtual machine in a device may comprise transmitting a response to a request when the request of virtual machine migration is received, receiving data related to an application run through the virtual machine from the device to request the migration of the virtual machine after transmitting the response, and running the virtual machine with the received data, wherein the step of running the virtual machine comprises converting an instruction word suitable for the virtual machine and an operating system using a dynamic binary converter included in virtualization layers.

In accordance with another aspect of the present disclosure, a virtualization processing unit of a device may comprise a data collecting unit for collecting data related to the application run through a virtual machine and a dynamic converter for converting the data of the application run through the virtual machine and an instruction word suitable for the device and an operating system.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1 illustrates a block diagram of a device to carry out the migration of a virtual machine according to the present disclosure;

FIG. 2 illustrates a process of virtual machine migration carried out between different types of devices according to an embodiment of the present disclosure;

FIG. 3 illustrates a process to carry out virtual machine migration between different types of devices in a host device according to the present disclosure;

FIG. 4 illustrates a process to be given the migration of a virtual machine in a device according to the present disclosure;

FIG. 5 illustrates a converting process of instruction words of a device according to an embodiment of the present disclosure;

FIG. 6 illustrates a process of a dynamic binary converter according to an embodiment of the present disclosure; and

FIG. 7 illustrates a migration process of a virtual machine according to an embodiment of the present disclosure.

Throughout the drawings, like reference numerals will be understood to refer to like parts, components and structures.

### DETAILED DESCRIPTION OF THE INVENTION

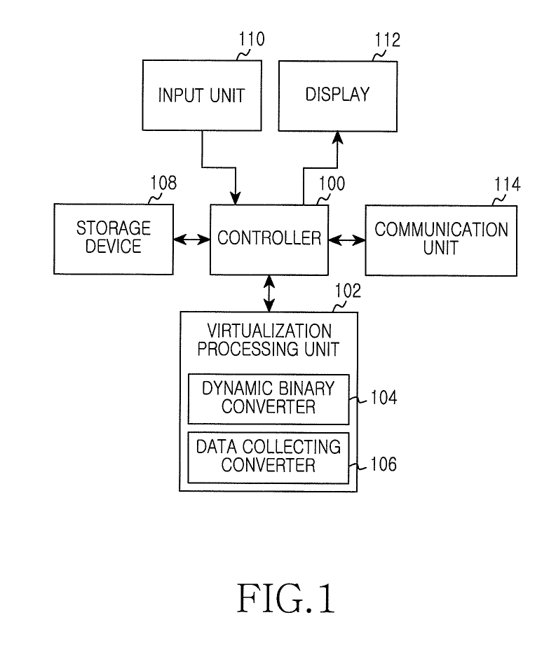

FIGS. 1 through 7, discussed below, and the various embodiments used to describe the principles of the present disclosure in this patent document are by way of illustration only and should not be construed in any way to limit the scope of the disclosure.

An apparatus and a method for enabling a virtual machine to be migrated between different types of devices will be disclosed herein according to the present disclosure. The different types of devices means that architectures to be used for operating are different each other and the devices permit another operating system as well as the devices' own operating system can be used. For example, the different types of devices may comprise a device such as a personal computer, a mobile telecommunication terminal, a notebook, a tablet computer, and an embedded device.

FIG. 1 illustrates a block diagram of a device to carry out the migration of a virtual machine according to the present disclosure.

Referring to FIG. 1, the device may comprise a controller 100, a virtualization processing unit 102, a storage device 108, an input unit 110, a display 112 and a communication unit 114, and the virtualization processing unit 102 may further comprise a dynamic binary converter 104 and a data collecting converter 106.

At first, the controller 100 may control the overall operation of the device. For example, if the device is a mobile telecommunication terminal, the controller 100 may carry out process and control for voice communication and data communication, and if the device is a personal computer, the controller 100 may decode an instruction, carry out arithmetic and logic calculation and process data. And also, the controller 100 may generate a virtual machine using virtualization technology, run an operating system different from the controller's 100 own operating system using the created virtual machine, and carry out an migration process for migrating the virtual machine to a device using an architecture different from the controller's 100 own architecture according to the present disclosure.

The virtualization processing unit 102 may carry out a migration process to migrate the virtual machine by the control of the controller 100.

The virtualization processing unit 102 may carry out a virtualization migration process to migrate image related to an application run through the virtual machine and application data comprising the operating system of the virtual machine to a different type of device using a different architecture.

The dynamic binary converter 104 of the virtualization processing unit 102 may manage an instruction word transfer between the device and the virtual machine. That is, if the dynamic binary converter 104 receives an instruction word to provide the virtual machine from the device, the dynamic binary converter 104 may convert the received instruction word into an instruction word type of the virtual machine, and if the dynamic binary converter 104 receives an instruction word to provide the device from the virtual machine, the dynamic binary converter 104 may convert the received instruction word into the instruction word type of the device.

The data collecting converter 106 of the virtualization processing unit 102 may collect the data of the migrated application through the migration process of the virtual machine.

In this example, the application data may become an image related to an application run through the virtual machine and comprise an operating system run through the virtual machine, an application run in the operating system and stored data of the application run before the migration. For example, if migration is carried out in the course of running memo pad application of window operating system through the virtual machine in the device, the data of memo pad application of window operating system becomes the application data. If not memo pad application but a word program included in window operating system is carried out in the device, the image of the word program is included in the application data.

The storage device 108 may include, for example, a Read Only Memory (ROM), a Random Access Memory (RAM), a Flash Memory, and such. The ROM may store micro code for process and control of the controller 100 and the virtualization processing unit 102 and various reference data. The method described hereunder of the present invention may be provided as one or more instructions in one or more software modules stored in the storage device. The software modules may be executed by the controller.

The RAM may become a working memory of the controller 100 and may store temporary data generated during carrying out various programs. And also, the storage device 108 may store image data of the application run through the virtual machine according to the present disclosure.

The input unit 110 may provide the controller 100 with key input data for operation of the device, and if the device is a personal computer, the input unit 110 may become a keyboard, a mouse and the like, and if the device is a mobile telecommunication terminal, a key pad comprising a plural of numeral keys and menu buttons may become the input unit 110. For example, the input unit 110 may provide the controller 100 with a request for the migration of a virtual machine.

The display 112 may display status information occurring during the operation of the device, the characters of the limited numerals, a great deal of moving pictures, images and the like, and display the operation of a virtual machine and the migration process of the virtual machine according to the present disclosure. The display 112 may comprise a color Liquid Crystal Display (LCD), an Active-Matrix Organic Light-Emitting Diode (AMOLED), and such. The display 112 may be used as an input apparatus if the display 112 is applied to a touch input type of device with a touch input apparatus installed. A touch sensitive display, called as a touch screen, may be used as the display. Touch input may be performed via the touch sensitive display.

The communication unit 114 may carry out the function for processing signal to be input and output through a communication module, and may migrate application data related to a virtual machine to a communicating module for network connection and near field communication and a peripheral device and transmit and receive a request message and a response message.

The function of the virtualization processing unit 102 may be carried out by the controller 100 of the device, but both of the two are illustrated and described herein. That is not for limiting the scope of the present disclosure, but for convenience of the explanation related to the embodiment, and the skilled in this art may appreciate that various modified embodiments will be made within the spirit of the present disclosure. For example, an embodiment that the above-mentioned functions are processed by the controller 100 can be contrived.

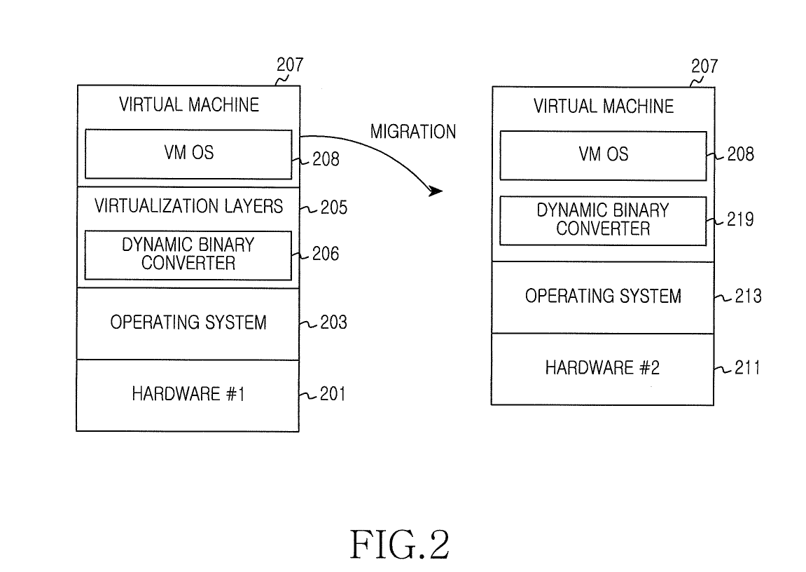

FIG. 2 illustrates a process of virtual machine migration carried out between different types of devices according to an embodiment of the present disclosure,

Referring to FIG. 2, the different types of devices may be designated as a first hardware 201 and a second hardware 211 respectively, and each of the hardware may use a different instruction set architecture (ISA). For example, it can be assumed that the first hardware 201 uses an operating system (e.g. a Windows operating system) 203 corresponding to a chipset of Intel Cooperation and the second hardware 211 uses an operating system (Mac OS) 213 corresponding to a chipset of Apple Cooperation.

In this example, the first hardware and the second hardware may comprise virtualization layers corresponding to the first and second hardware respectively, and the virtualization layers may comprise a dynamic binary converter corresponding to the architecture of the hardware. At first, the first hardware 201 may create a virtual machine using virtualization software (for example, a QEMU processor emulator) corresponding to the virtualization layers 205 during being run with an operating system. That is, the first hardware 201 may run the operating system 208 of a virtual machine 207 (for example, Linux) at the same time within his own operating system.

In this example, the first hardware may transfer an instruction word between the virtual machine 207 and the operating system 203 using the dynamic binary converter 206 included in the virtualization layers 205. That is because the type of instruction word supporting the operating system 203 of the virtual machine 207 is different from that of the first hardware 201 and, therefore, the instruction word has to be converted into suitable for each other using the dynamic binary converter 206.

A user of the first hardware 201 creating the virtual machine 207 as above-mentioned may carry out the migration of the virtual machine to migrate the created virtual machine 207 to other hardware, and may make the process of the virtual machine that is already run in other hardware be carried out continuously.

In general, the migration of the virtual machine may be allowed only between hardware having the same instruction set architecture. That is, it is impossible to make the migration of a virtual machine between different types of devices using different architectures each other, as shown in FIG. 2, as the first hardware 201 uses chipset of Intel Cooperation and the second hardware 211 uses a chipset of Apple Cooperation.

But, according to the present disclosure, the migration of the virtual machine between different types of hardware is made possible by enabling the transfer of an instruction word between the virtual machine and the second hardware 211 using the dynamic binary converter 219 of the second hardware 211, after the virtual machine 207 created in the first hardware 201 is migrated to the second hardware 211.

The second hardware 211 to which the virtual machine 207 of the first hardware 201 is migrated as above-mentioned may carry out the conversion of an instruction word between the virtual machine received from the first hardware 201 and the operating system 213 of the second hardware 211 using the dynamic binary converter 219 and make continuous use of process be possible.

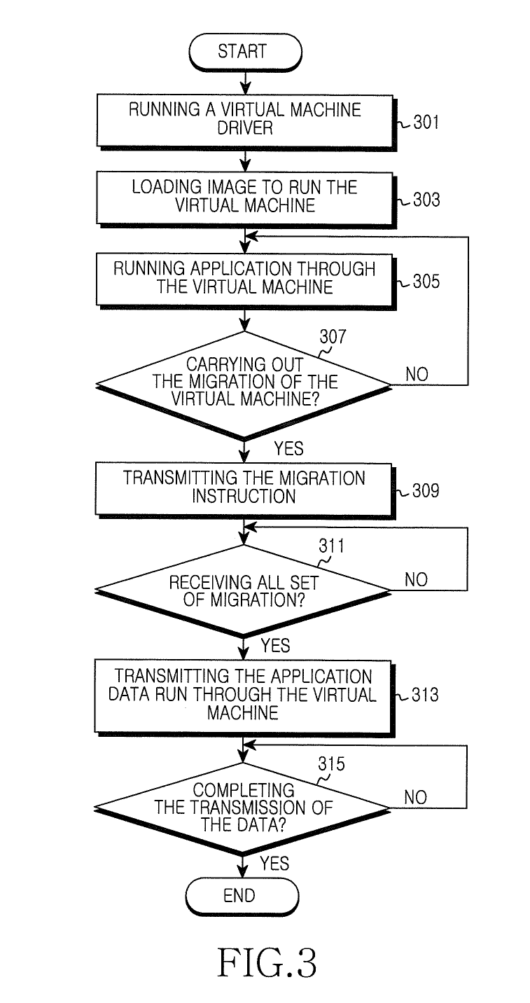

FIG. 3 illustrates a process to carry out virtual machine migration between different types of devices in a host device according to the present disclosure.

Referring to FIG. 3, the device may become a device running a different operating system as well as the device's own operating system, and the device may comprise a personal computer, a mobile telecommunication terminal, a notebook and an embedded device. And also, the migration of a virtual machine means technology by which the virtual machine run in the device may be migrated to a peripheral device connected previously.

The device to carry out the migration of the virtual machine as above-mentioned may operate a driver of the virtual machine in step 301 and then advance to step 303 for loading an image to run with the virtual machine. In this example, the image may become an image of an operating system different from that of the device, and window operating system of Microsoft cooperation may be run at the same time using the virtual machine run through an virtualization driver (virtualization software, for example, QEMU) in the device using Linux operating system in from step 301 to 303 according to the present disclosure.

And then, the device may advance to step 305 for running an application through the virtual machine. That is, an application such as a memo pad, a web browser, a game, a word program and the like that run in window operating system to run through the virtual machine may be run in the device.

And then, the device may advance to step 307 for verifying whether the virtual machine migration to migrate the virtual machine run previously to in a peripheral device is carried out or not. In this example, the peripheral device means a different type of device to use an instruction set architecture (ISA) different from that of the device to operate the virtual machine.

If it is determined in step 307 that the virtual machine migration is not carried out, the device may execute step 305 once more.

If it is determined in step 307 that the virtual machine migration is carried out, the device may advance to step 309 and advance to step 311 to verify whether all set for the migration is received from the different type of device in step 311, after transmitting the instruction word of migration to the different type of device by advancing to step 309.

If it is determined in step 311 that all set for migration is not received from the different type of the device, the device may doesn't determine that the migration is all set and carry out step 311 once more

If it is determined in step 311 that all set for migration is received from the different type of device, the device may determine that the migration is all set and may advance to step 313 to transmit the application data run through the virtual machine. In this example, the application data becomes an image related to the application run through the virtual machine, and may comprise an operating system run through the virtual machine, an application run in the operation system and stored data of the application operated before the migration. For example, if the device makes the migration in the course of running a memo pad application of window operating system through the virtual machine, the application data may become window operating system and the data made in the memo pad application. If the device runs not a memo pad but a word program included in window operating system, the application data may comprise a word program image.

And then, the device may advance to step 315 for verifying the completion of the transmission of the application data.

If it is determined that step 315 is not completed, the device may carry out step 313 once more.

If it is determined that step 315 is completed, the device may terminate the algorithm.

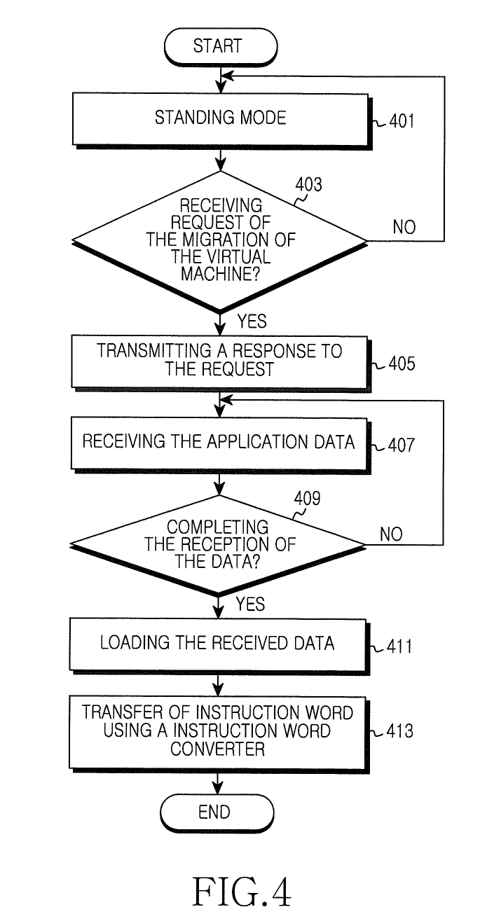

FIG. 4 illustrates a process to be given the migration of the virtual machine in a device according to the present disclosure.

Referring to FIG. 4, the device becomes a different type of device using an instruction set architecture (ISA) different from that of the device to migrate the virtual machine.

The device to which the virtual machine is migrated as above-mentioned may carry out a standing mode in step 401, and then advance to step 403 for verifying whether the request of the virtual machine migration is received from the device to migrate the virtual machine.

If it is not determined in step 403 that the request of the virtual machine migration is not received, the device may advance to step 401 to maintain the standing mode.

If it is determined in step 403 that the request of the virtual machine migration is received, the device may advance to step 405 for transmitting a response to accept the request of the migration to the device requesting the virtual machine migration.

And then, the device may advance to step 407 for verifying whether the reception of the data is completed in step 409, after a dynamic binary converter for application data is received from the device. In this example, the application data may become an image related to the application run through the virtual machine and may comprise an operating system run through the virtual machine, an application run in the operating system and the stored data of the application run before the migration, and this is to receive the application data comprising the operating system residing in the memory of the device to migrate the virtual machine.

If the reception of the data is not completed in step 409, the device may return to step 407 for carrying out the reception process of the data once more.

In the meanwhile, if it is verified that the reception of the data is completed in step 409, the device may advance to step 411 for carrying out the loading process of the reception data.

That is, the deceive may return to the status before the migration of the virtual machine by receiving the operating system image, the application image and the stored data received from the device requesting the migration. For example, the device may restore a document application run until the virtual machine is migrated and the form of a document made until the migration happens using the received data.

And then, the device may advance to step 413 for running the migrated virtual machine. In this example, the architecture of the operating system of the device is different from that of the operating system of the migrated virtual machine, and therefore the device may transmit an instruction word to the virtual machine and the device's hardware using the device's dynamic binary converter.

And then, the device may terminate the algorithm.

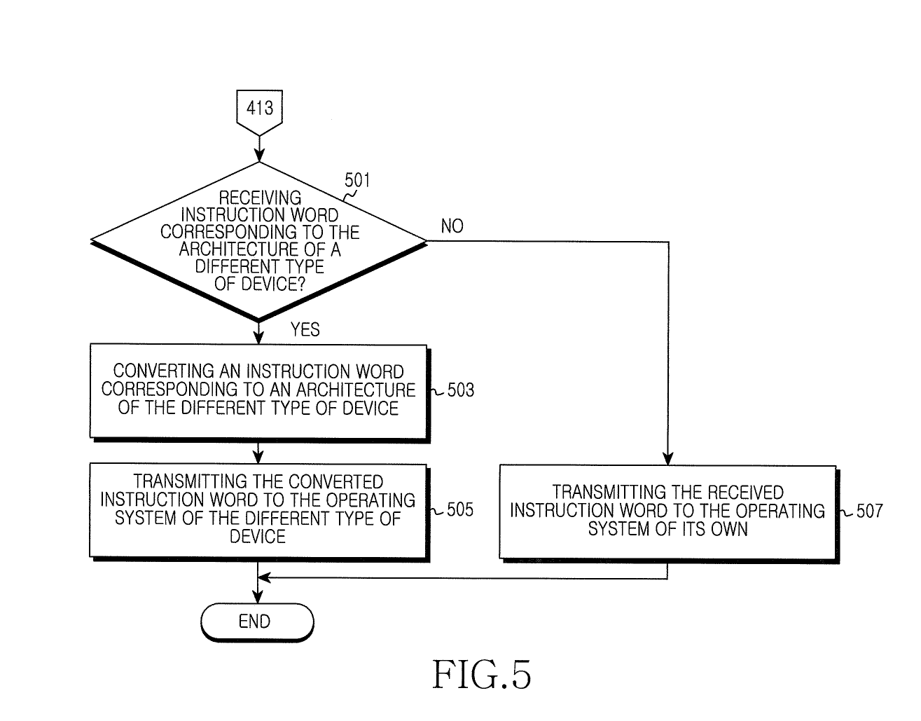

FIG. 5 illustrates a converting process of device instruction words according to an embodiment of the present disclosure.

Referring to FIG. 5, the device may carry out step 413 in FIG. 4 for running the migrated machine.

And then, the device may advance to step 501 for verifying whether an instruction word corresponding to the architecture of a different type of device is received.

If it is determined in step 501 that an instruction word corresponding to the device's architecture is received, the device may advance to step 507 for transmitting the received instruction word to the device's operating system or hardware.

If it is determined in step 501 that an instruction word corresponding to the architecture of a different type of device is received, the device may advance to step 503 for converting the received instruction word into the instruction word corresponding to the architecture of the different type of device.

And then, the device may advance to step 505 transmitting the converted instruction word to the operating system or hardware of the different type of device.

And then, the device may terminate the algorithm.

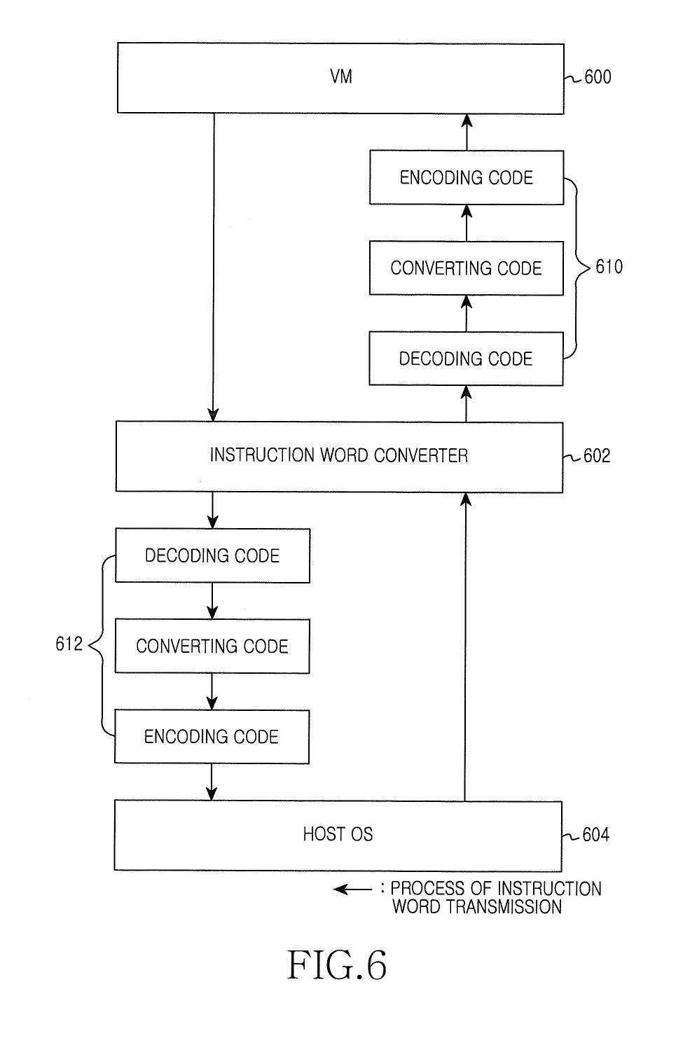

FIG. 6 illustrates an operation process of the dynamic binary converter according to an embodiment of the present disclosure.

Referring to FIG. 6, the dynamic binary converter may process the transfer of instruction word between a migrated virtual machine 600 and the device 604 to migrate the virtual machine 600.

At first, if the virtual machine 600 runs application using an operating system corresponding to a different architecture, it is impossible to control the migrated virtual machine 600 using the instruction word for the device.

Therefore, the dynamic binary converter 602 may decode instruction word (code) supplied from OS of the device 604 which is designated as HOST OS, may convert the decoded instruction word into a type of instruction word corresponding to the virtual machine 600, and then the dynamic binary converter 602 may provide the virtual machine 604 with the converted instruction word 610.

And also, the dynamic binary converter 602 may decode the instruction word received from the virtual machine 600, may convert the decoded instruction word into a type of instruction word corresponding to HOST OS and then the converted instruction word may be encoded for supplying to HOST OS 604, 612.

That is, the dynamic binary converter 602 may carry out a function that it makes to be possible for an instruction word to be transferred between the device 604 and the virtual machine that supports different architecture type of instruction word each other.

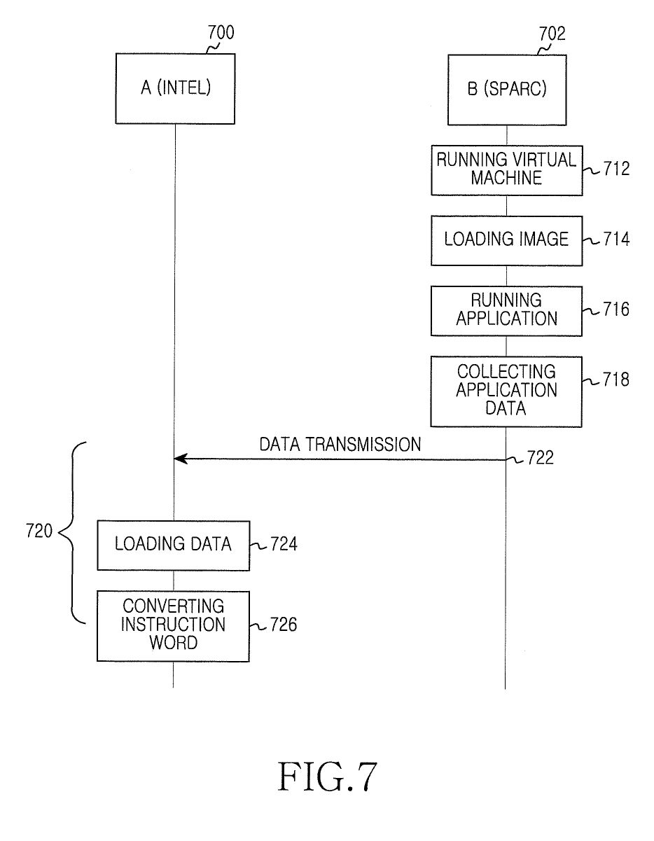

FIG. 7 illustrates a migration process of a virtual machine according to an embodiment of the present disclosure.

Referring to FIG. 7, the process of the virtual machine migration will be explained and the process of the virtual machine migration in an example embodiment between one device 700 in which an Intel central processing unit (CPU) is installed and another device 702 in which SPARC CPU is installed will be exemplified.

At first, after a virtual machine is created in the device 702 in which SPARC CPU is installed, an image of different operating system can be loaded 714. Hence, the device 702 may use Solaris operating system, but a virtual machine 712 with a Windows operating system of Microsoft cooperation may be run at the same time and an application suitable for Windows operating system may be run 716.

As above-mentioned, the virtualization technology to run two or more operating system in the device 702 using Solaris operating system through the virtual machine may be used, and at the same time the process of the virtual machine migration in which the virtual machine is migrated to the device having Intel CPU may be carried out 720. As above-mentioned, the virtualization migration may enable a user to run the application executed previously in a stream in spite of change into the device using different architecture.

The device 702 to carry out the virtual machine migration may collect application data 718 related to the device's 702 virtual machine. In this example, the application data may become an image related to the application run through the virtual machine and may comprise an operating system run through the virtual machine, an application run in the operating system and the stored data of the application run before the migration. For example, if the device carries out the migration in the course of running memo pad application of window operating system through the virtual machine, the application data may comprise window operating system and the data made by memo pad application. For example, if the device runs not memo pad included in window operating system but a word program, the application data may comprise the image of the word program.

And then, the device 702 to carry out the virtual machine migration may provide a device 700 using a different architecture with the collected application data 722.

As above-mentioned, the device 700 receiving the application data through the virtual machine migration may load the received data 724, and then the device 700 may convert an instruction word transmitted between the devices using the dynamic binary converter 726 included in the device's 700 virtualization layers. In this example, the device 700 may load an operating system corresponding to the virtual machine, and then may load the received data by restoring the application as the status run before the migration of the virtual machine. Also, computer readable storage medium storing one or more programs, the one or more programs comprising instructions, which when executed by a portable electronic device with a touch-sensitive display, cause the portable electronic device to perform a method comprising, collecting log information comprising the daily life information from at least one electronic device, analyzing the log information collected and deciding at least one topic representing the daily life information, generating at least one sentence representing the daily life information using the at least one topic decided, and displaying the generated at least one sentence.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As above-mentioned, the aspect of the present disclosure is for migrating a virtual machine between different types of devices and a virtual machine run in one device may be migrated to a different type of device using a different architecture.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. An apparatus to migrate a virtual machine in a device, the apparatus comprising:
a display configured to output a process of the migration of the virtual machine;
a virtualization processing unit configured to create the virtual machine to run an application corresponding to a plurality of operating systems and collect data related to the application run through the virtual machine; and
a controller configured to transmit the data related to the application run through the virtual machine to a peripheral device using a different instruction set architecture (ISA).

2. The apparatus of claim 1, wherein the data related to the application run through the virtual machine comprises at least one selected from a group consisting of an operating system run through the virtual machine, the application run in the operating system and stored data of the application run before the migration of the virtual machine.

3. The apparatus of claim 1, wherein the controller is further configured to load an image of the operating system to run the virtual machine and run the application using the image of the operating system.

4. An apparatus configured to receive a migration of a virtual machine in a device, the apparatus comprising:
a controller configured to receive data related to an application run through the virtual machine from a device to request the migration of the virtual machine, after a response to the request for the migration of the virtual machine is transmitted and when the request of the migration of virtual machine is received; and
a virtualization processing unit configured to run the virtual machine using the received data,
wherein the virtualization processing unit is further configured to convert an instruction word type suitable for the virtual machine and an operating system of the virtual machine using a dynamic binary converter included in virtualization layers.

5. The apparatus of claim 4, wherein the device to request the migration of the virtual machine is a different type of device using an instruction set architecture (ISA) different from that of the device configured to receive the migration of the virtual machine.

6. The apparatus of claim 4, wherein the virtualization processing unit is further configured to convert an instruction word type received from the operating system into an instruction word type of the virtual machine using the dynamic binary converter and convert an instruction word received from the virtual machine into an instruction word type of the operating system.

7. The apparatus of the claim 4, wherein the virtualization processing unit is further configured to run the virtual machine by restoring the application as a status run before the migration of the virtual machine in the device requesting the migration of the virtual machine.

8. The apparatus of claim 4, wherein the virtualization processing unit is further configured to run the application using the operating system of the virtual machine.

9. A method for migrating a virtual machine in a device, the method comprising:
creating a virtual machine and running an application corresponding to a plurality of operating systems;
collecting, data related to the application run through the virtual machine; and
providing the collected data to a peripheral device using a different instruction set architecture (ISA).

10. The method of claim 9, wherein the data related to the application run through the virtual machine comprises at least one selected from a group consisting of an operating system run through the virtual machine, an application run in the operating system and stored data of application run before the migration.

11. The method of claim 9 further comprising:
loading an image of the operating system to run the virtual machine; and
running the application using the image of the operating system.

12. A method for receiving a migration of a virtual machine in a device, the method comprising:
transmitting a response to a request, when the request for the migration of the virtual machine is received;
receiving data related to the application run through the virtual machine from the device requesting the migration of the virtual machine after transmitting the response; and
running the virtual machine using the received data,
wherein the running the virtual machine comprises converting an instruction word type suitable for the virtual machine and an operating system of the virtual machine using a dynamic binary converter included in virtualization layers.

13. The method of claim 12, wherein the device to request the migration of the virtual machine is a different type of device using an instruction set architecture (ISA) different form that of the device for carrying out the migration of the virtual machine.

14. The method of claim 12, wherein converting the instruction word type suitable for the virtual machine and the operating system comprises:
converting an instruction word received from the operating system into an instruction word type of the running virtual machine; and
converting an instruction word received from the virtual machine into the instruction word type of the operating system.

15. The method of claim 12, wherein running the virtual machine using the received data comprises:
restoring the application to a status run before the migration of the virtual machine in the device requesting the migration of the virtual machine.

16. The method of claim 12, wherein running the virtual machine using the received data comprises:
running the application using the operating system of the virtual machine.

17. A virtualization processing unit of a device comprising:
a data collecting unit configured to collect data related to an application run through a virtual machine; and
a dynamic binary converter configured to convert the data related to the application run through the virtual machine and an instruction word type suitable for the virtual machine and an operating system of the virtual machine.

18. The virtualization processing unit of claim 17, wherein the data related to the application run through the virtual machine comprises at least one selected from a group consisting of an operating system run in the operating system, an application run in the operating system and stored data of the application run until the migration.

19. The virtualization processing unit of claim 17, wherein the virtualization processing unit of the device is further configured to collect information for migrating to a different type of device using a different instruction set architecture (ISA).

20. The virtualization processing unit of claim 17, wherein the virtualization processing unit of the device unit is further configured to convert an instruction word type of the virtual machine and the operating system using the dynamic binary converter when the virtual machine is migrated from a different type of device using a different instruction set architecture (ISA).
